(19) United States
(12) Patent Application Publication
(10) Pub. No.: US 2025/0362869 A1
(43) Pub. Date: Nov. 27, 2025

(54) SYSTEMS AND METHODS FOR PERFORMING FLOATING POINT MAC OPERATIONS WITH IMPROVED CIM

(71) Applicant: Taiwan Semiconductor Manufacturing Company, Ltd., Hsinchu (TW)

(72) Inventor: Hiroaki Ishii, Hsinchu (TW)

(73) Assignee: Taiwan Semiconductor Manufacturing Company, Ltd., Hsinchu (TW)

(21) Appl. No.: 19/287,378

(22) Filed: Jul. 31, 2025

Related U.S. Application Data
(63) Continuation of application No. 18/636,914, filed on Apr. 16, 2024.
(60) Provisional application No. 63/609,658, filed on Dec. 13, 2023.

(51) Int. Cl. G06F 7/487

(52) U.S. Cl. CPC G06F 7/4876

(57) ABSTRACT

A computing-in-memory circuit (CIM) circuit includes an input circuit configured to receive: N first inputs and N second inputs; N multiplier circuits, each configured to multiply a corresponding input pair to generate a corresponding one of N products; a shifting circuit configured to align the N products according to a largest exponent sum to generate a corresponding one of N aligned products; an adder circuit configured to sum a respective pair of the N aligned products to generate a sum result; and a padding circuit configured to: (i) determine a padding number based on a bit position of a largest non-zero value in the sum result, (ii) shift the sum result by a number of bits corresponding to the padding number to generate a shifted sum result, and (iii) apply a padding pattern having a length of the padding number to the shifted sum result to generate a padded sum.

### CROSS-REFERENCE TO RELATED APPLICATIONS

This application is a continuation of U.S. patent application Ser. No. 18/636,914, filed Apr. 16, 2024, which claims priority to and the benefit of U.S. Provisional Application No. 63/609,658, filed Dec. 13, 2023. Each of the foregoing applications are incorporated herein by reference in their entireties for all purposes.

### BACKGROUND

Computer artificial intelligence (AI) has been built on machine learning, for example, using deep learning techniques. With machine learning, a computing system organized as a neural network computes a statistical likelihood of a match of input data with prior computed data. A neural network refers to a number of interconnected processing nodes that enable the analysis of data to compare an input to “trained” data. Trained data refers to computational analysis of properties of known data to develop models to use to compare input data. An example of an application of AI and data training is found in object recognition, where a system analyzes the properties of many (e.g., thousands or more) of images to determine patterns that can be used to perform statistical analysis to identify an input object.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a block diagram of a data computation circuit for performing MAC operations on floating point numbers with improved accuracy of compute in memory (CIM), in accordance with some embodiments.

FIG. 2 illustrates an example of shifting a sum result from the data computation circuit of FIG. 1, in accordance with some embodiments.

FIG. 3 is a graph mapping a number of bits padded and a corresponding value for the fraction of the sum result from the data computation circuit of FIG. 1, in accordance with some embodiments.

FIG. 4 is a flow diagram of a method for determining padding bits for the data computation circuit of FIG. 1, in accordance with some embodiments.

FIG. 5 is a flow diagram of a method for setting the target padding curve of FIG. 4, in accordance with some embodiments.

FIG. 6 is a flow diagram of a method for determining whether to pad the sum result of the data computation circuit of FIG. 1, in accordance with some embodiments.

FIG. 7 is a flow diagram of a method for padding data determination of FIG. 6, in accordance with some embodiments.

FIG. 8 is a block diagram of one search component for the data computation circuit of FIG. 1, in accordance with some embodiments.

FIG. 9 is a block diagram of a bit extraction component for the data computation circuit of FIG. 1, in accordance with some embodiments.

FIG. 10 is a block diagram of a concatenation component for the data computation circuit of FIG. 1, in accordance with some embodiments.

FIG. 11 illustrates a flow chart of an example method of performing MAC operations on floating point numbers with improved accuracy of compute in memory (CIM), in accordance with various embodiments.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over, or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” “top,” “bottom” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Neural networks compute “weights” to perform computation on new data (an input data “word”). Neural networks use multiple layers of computational nodes, where deeper layers perform computations based on results of computations performed by higher layers. Machine learning currently relies on the computation of dot-products and absolute difference of vectors, typically computed with multiply-accumulate (MAC) operations performed on the parameters, input data and weights. The computation of large and deep neural networks typically involves so many data elements, and thus it is not practical to store them in processor cache. Accordingly, these data elements are usually stored in a memory.

Thus, machine learning is very computationally intensive with the computation and comparison of many different data elements. The computation of operations within a processor is orders of magnitude faster than the transfer of data elements between the processor and main memory resources. Placing all the data elements closer to the processor in caches is prohibitively expensive for the great majority of practical systems due to the memory sizes needed to store the data elements. Thus, the transfer of data elements becomes a major bottleneck for AI computations. As the data sets increase, the time and power/energy a computing system uses for moving data elements around can end up being multiples of the time and power used to actually perform computations.

In this regard, computing-in-memory (CIM) circuits have been proposed to perform such MAC operations. Similar to a human brain, a CIM circuit instead conducts data processing in situ within a suitable memory circuit. The CIM circuit suppresses the latency for data/program fetch and output results upload in corresponding memory (e.g. a memory array), thus solving the memory (or von Neumann) bottleneck of conventional computers. Another key advantage of the CIM circuit is the high computing parallelism, thanks to the specific architecture of the memory array, where computation can take place along several current paths at the same time. The CIM circuit also benefits from the high density of multiple memory arrays with computational devices, which generally feature excellent scalability and the capability of 3D integration. As a non-limiting example, the CIM circuit targeted for various machine learning applications can perform the MAC operations locally within the memory (i.e., without having to send data elements to a host processor) to enable higher throughput dot-product of neuron activation and weight matrices, while still providing higher performance and lower energy compared to computation by the host processor.

The data elements, processed by the CIM circuit, have various types or forms, such as integers number and floating point numbers. A floating point number is typically represented by a sign portion, an exponent portion, and a significand (mantissa) portion that consists of the significant digits of the number. For example, a floating point number format specified by the Institute of Electrical and Electronics Engineers (IEEE®) is thirty-two bits in size and includes twenty-three mantissa bits, eight exponent bits, and one sign bit. Another floating point number format is sixteen bits in size, which includes ten mantissa bits, five exponent bits, and one sign bit.

In machine learning applications, the CIM circuit is frequently configured to process dot product multiplications based on performing MAC operations on a large number of data elements (e.g., an input word vector and a weight matrix), which may each be in the form of floating point numbers, and then process addition (or accumulation) of such dot products. Multiplication of each floating point number pair, generally, includes addition of respective exponent portions (generating an exponent sum) and multiplication of respective mantissa portions (generating a mantissa product). Further, the exponent sum of each floating point number pair is compared to a maximum exponent sum among the plural floating point number pairs to generate an exponent difference. Such exponent differences are utilized to align the exponent portions of the different floating point number pairs, so as to shift the corresponding mantissa products. The shifted mantissa products are summed, with an exponent of the maximum exponent sum, to reach the final sum.

With such an approach, the summation of one or more pairs of products may generate or result in a relatively small output (e.g., the sum result of the shifted mantissa products). Because the output may be relatively small (e.g., a fraction), number loss may occur from the summation given the constraints of the predefined number of bits (depending on the format) allocated for a respective value. The potential occurrences of the number loss may introduce errors when computing the final sum or cause information loss because of the relatively small output from a certain product pair summation.

For example, when a relatively small sum of the products (e.g., that is non-zero) is obtained, a number of smaller bits may have been disregarded because of the maximum number of bits for a data element (e.g., 8 bits, 16 bits, 32 bits, 64 bits, etc.). In such cases, the relatively small sum may be shifted to comply with a predefined or a specified format, such as but not limited to FP16, FP32, or FP64 formats, e.g., so that an integer portion of the sum is occupied with a non-zero value (shifted from the fraction portion of the sum). However, in certain systems, each shifted bit may be automatically filled with zero, which may not accurately represent the actual value of the result from summing the corresponding product pair. Thus, automatically filling the shifted bits with zeros can lead to an erroneous result of the summation, and the potential error level (e.g., the difference between a computed result and an expected result) may further increase based on at least the number of bits shifted (or the number of zero fills), the number of relatively small values resulting from the summations, or the number of iterations to obtain the final sum (e.g., the number of elements to be added to each other).

The present disclosure provides various embodiments of a compute-in-memory (CIM) circuit that can determine whether to pad the sum result (e.g., the sum of the shifted mantissa products) with non-zero values subsequent to the summation and shifting process. The disclosed CIM circuit can include one or more features or components for detecting the bit position of at least one non-zero value (e.g., ‘1’ bit) from the sum result to determine whether to execute a padding process. For instance, to satisfy a predefined format (e.g., setting integer part to 1), the disclosed CIM circuit may left shift the sum result and pad one or more least significant bit (LSB), corresponding to the number of shifted bits, with a padding pattern. The padding pattern can include one or more non-zero values to compensate for or minimize loss of information during the summation process of the (e.g., mantissa) products. The padding pattern can be predetermined, configured, updated, or adjusted according to a configured target curve (e.g., desired output for the faction portion). The disclosed CIM circuit can include a policy for the padding bits. For instance, a relatively small padding value can be applied if the number of padding bits is relatively small (e.g., relatively small error), and the padding value can gradually increase as the number of padding bits gets bigger (e.g., relatively larger error). Hence, by applying or concatenating one or more non-zero values instead of all zero values to the shifted sum result (e.g., in the case of floating point operation of CIM application), the disclosed CIM circuit can reduce the error level potentially caused by the loss of information and increase/optimize the accuracy of the final sum (e.g., padded sum).

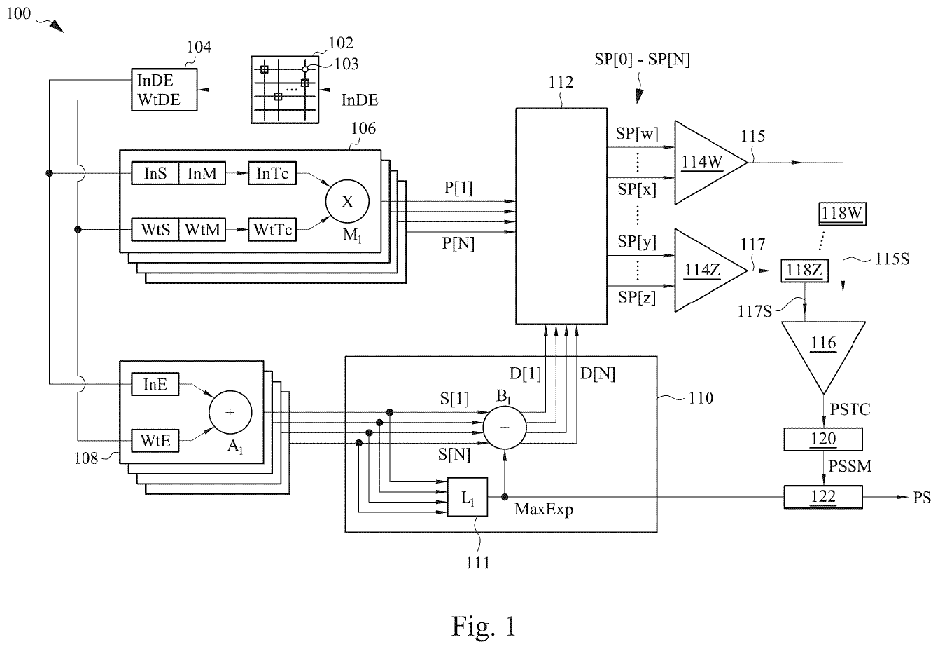

FIG. 1 illustrates a block diagram of a data computation circuit 100, in accordance with some embodiments of the present disclosure. In the illustrated embodiment depicted in FIG. 1, the data computation circuit 100, also referred to as (e.g., CIM) circuit 100 or memory circuit 100, includes various components collectively configured to perform in-memory computations (e.g., multiply-accumulate (MAC) operations) on an input word vector and a weight matrix. The input word vector can include a plural number (N) of input data elements InDE, and the weight matrix can include a plural number (Nd) of weight data elements WtDE. In various embodiments, each of the input data elements InDE and the weight data elements WtDE may include a floating point number.

As shown, the circuit 100 includes a memory circuit 102, an input circuit 104, a number of multiplier circuits 106, a number of summing circuits 108, a difference circuit 110 (e.g., sometimes referred to as a subtractor circuit 110), a shifting circuit 112, one or more adder circuits (or adder trees) 114w-z (e.g., sometimes referred to as adder circuit(s) 114), at least one adder circuit (or adder tree) 116, one or more padding circuits 118w-z (e.g., sometimes referred to as padding circuit(s) 118), a first converter 120, and a second converter 122. The circuit 100 can include additional or alternative circuits, components, or apparatuses not limited to those discussed herein. In some embodiments, the number of multiplier circuits 106 may correspond to the number of summing circuits 108. For example, the circuit 100 may include N (the number of weight/input data elements WtDE/InDE) multiplier circuits 106 and N (the number of weight/input data elements WtDE/InDE) summing circuits 108. It should be appreciated that the block diagram of the circuit depicted in FIG. 1 is simplified, and thus, the circuit 100 can include any of various other components while remaining within the scope of the present disclosure.

The memory circuit 102 may include one or more memory arrays and one or more corresponding circuits. The memory arrays are each a storage device including a number of storage elements 103, each of the storage elements 103 including an electrical, electromechanical, electromagnetic, or other device configured to store one or more data elements, each data element including one or more data bits represented by logical states. In some embodiments, a logical state corresponds to a voltage level of an electrical charge stored in a portion or all of a storage element 103. In some embodiments, a logical state corresponds to a physical property, e.g., a resistance or magnetic orientation, of a portion or all of a storage element 103.

In some embodiments, the storage element 103 includes one or more static random-access memory (SRAM) cells. In various embodiments, an SRAM cell includes a number of transistors, e.g., a five-transistor (5T) SRAM cell, a six-transistor (6T) SRAM cell, an eight-transistor (8T) SRAM cell, a nine-transistor (9T) SRAM cell, etc. In some embodiments, an SRAM cell includes a multi-track SRAM cell. In some embodiments, an SRAM cell includes a length at least two times greater than a width.

In some embodiments, the storage element 103 includes one or more dynamic random-access memory (DRAM) cells, resistive random-access memory (RRAM) cells, magnetoresistive random-access memory (MRAM) cells, ferroelectric random-access memory (FeRAM) cells, NOR flash cells, NAND flash cells, conductive-bridging random-access memory (CBRAM) cells, data registers, non-volatile memory (NVM) cells, 3D NVM cells, or other memory cell types capable of storing bit data.

In addition to the memory array(s), the memory circuit 102 can include a number of circuits to access or otherwise control the memory arrays. For example, the memory circuit 102 may include a number of (e.g., word line) drivers operatively coupled to the memory arrays. The drivers can apply signals (e.g., voltages) to the corresponding storage elements 103 so as to allow those storage elements 103 to be accessed (e.g., programmed, read, etc.). For another example, the memory circuit 102 may include a number of programming circuits and/or read circuits that are operatively coupled to the memory arrays.

The memory arrays of the memory circuit 102 are each configured to store a number of the weight data elements WtDE. In some embodiments, the programming circuits may write the weight data elements WtDE into corresponding storage elements 103 of the memory arrays, respectively, while the reading circuit may read bits written into the storage elements 103, so as to verify or otherwise test whether the written weight data elements WtDE are correct. The drivers of the memory circuit 102 can include or be operatively coupled to a number of input activation latches that are configured to receive and temporarily store the input data elements InDE. In some other embodiments, such input activation latches may be part of the input circuit 104, which can further include a number of buffers that are configured to temporarily store the weight data elements WtDE retrieved from the memory arrays of the memory circuit 102. As such, the input circuit 104 can receive the input data elements InDE and the weight data elements WtDE.

In various embodiments of the present disclosure, the input word vector (including, e.g., the input data elements InDE) and the weight matrix (including, e.g., the weight data elements WtDE), on which the circuit 100 is configured to perform MAC operations, each include a number of floating point numbers. As such, each of the data elements InDE and weight data elements WtDE includes a sign bit, a plural number of exponent bits, and a plural number of mantissa bits (sometimes referred to as fraction bits).

For example, each of the data elements InDE and weight data elements WtDE has a BF16 format, also referred to as a bfloat format or brain floating-point format in some embodiments, in which a first bit represents a sign of a floating-point number, a subsequent eight bits represent an exponent of the floating-point number, and the final seven bits represent the mantissa, or fraction, of the floating-point number. Because the mantissa is configured to start with a non-zero value, the final seven bits of each stored data element represent an eight-bit mantissa having a first, most significant bit (MSB) equal to one.

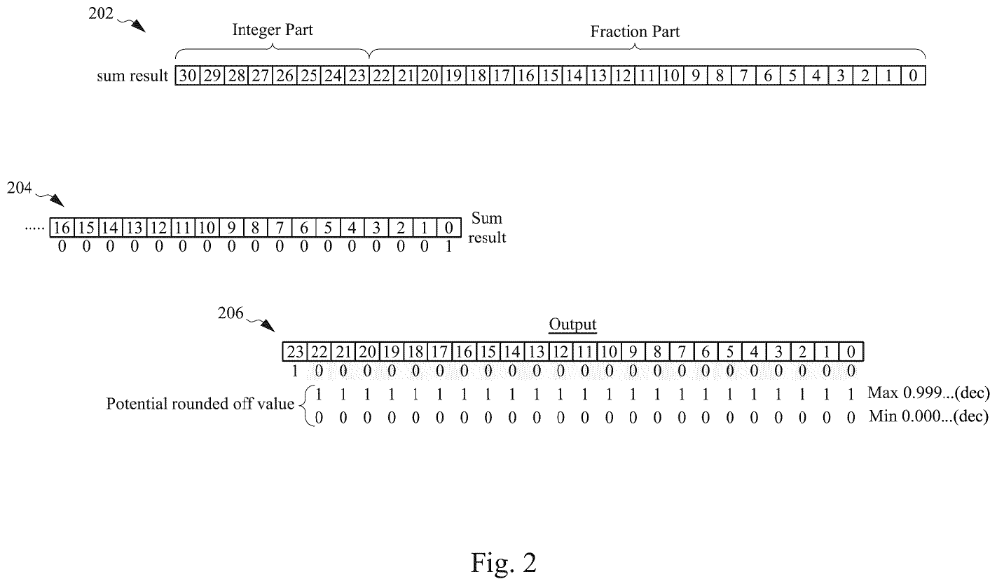

In some embodiments, each of the data elements InDE and the weight data elements WtDE has a FP16 format, also referred to as a half precision format, in which a first bit represents a sign of a floating-point number, a subsequent five bits represent an exponent of the floating-point number, and the final ten bits represent the mantissa, or fraction, of the floating-point number. In this case, the final ten bits of each stored data element represent an eleven-bit mantissa having a first MSB equal to one. In some other embodiments, each of the data elements InDE and the weight data elements WtDE has a floating-point format other than a BF16 or FP16 format, e.g., another 16-bit format, a 32-bit, 64-bit, 128-bit, or 256-bit format, or a 40-bit or 80-bit extended precision format. The sign and mantissa of a data element representing a floating-point number are collectively referred to as a signed mantissa of the floating-point number. The MSB of a mantissa is referred to as a hidden bit or hidden MSB. For purposes of providing examples herein, such as described in conjunction with at least FIGS. 2-11, FP32 (e.g., 32-bit) format can be used as an exemplary format, although it should be noted that other formats can be used similarly to perform or obtain the benefit of the features or operations discussed herein.

Referring still to FIG. 1, the input circuit 104 is configured to output entireties of each data element of data elements InDE and WtDE to each of the multiplier circuits 106 and the summing circuits 108. In some embodiments, the input circuit 104 is configured to output the signed mantissa of each data element to the multiplier circuit 106 and the exponent of each data element to the summing circuit 108, which will be described as follows.

The multiplier circuits 106 are each an electronic circuit, e.g., an integrated circuit (IC), configured to receive, e.g., from the input circuit 104, a sign bit InS and a mantissa InM (collectively a signed mantissa InS/InM) of each of the N data elements InDE, and a sign bit WtS and a mantissa WtM (collectively a signed mantissa WtS/WtM) of each of the N data elements WtDE. The summing circuits 108 are each an electronic circuit, e.g., an IC, configured to receive, e.g., from the input circuit 104, an exponent InE of each of the N data elements InDE, and an exponent WtE of each of the N data elements WtDE.

The multiplier circuits 106 may each include one or more data registers (not shown) configured to receive the instances of signed mantissas InS/InM and WtS/WtM. In the embodiment depicted in FIG. 1, the multiplier circuit 106 is configured to receive the instances of signed mantissas InS/InM and WtS/WtM corresponding to data elements InDE and WtDE. In some other embodiments, the multiplier circuit 106 includes the one or more data registers configured to receive the instances of signed mantissas InS/InM and/or WtS/WtM including the hidden MSBs. In some embodiments, the multiplier circuit 106 includes the one or more data registers configured to add the hidden MSBs to the received instances of signed mantissas InS/InM and/or WtS/WtM.

The multiplier circuit 106 may include logic circuitry (not shown) configured to, in operation, reformat each instance of signed mantissa InS/InM to a two's complement mantissa InTC, also referred to as reformatted mantissa InTC, and to reformat each instance of signed mantissa WtS/WtM to a two's complement mantissa WtTC, also referred to as reformatted mantissa WtTC. Reformatted mantissa InTC has a same number of bits as signed mantissa InS/InM, and reformatted mantissa WtTC has a same number of bits as signed mantissa WtS/WtM.

The multiplier circuit 106 may include one or more logic gates MI configured to, in operation, multiply some or all of the instances of reformatted mantissas InTC with some or all of the instances of reformatted mantissas WtTC, thereby generating N products, e.g., P[1] to P[N]. In various embodiments, the one or more logic gates M1 include one or more AND or NOR gates or other circuits suitable for performing some or all of a multiplication operation. The one or more logic gates M1 are configured to, in operation, generate each of the products P[1] to P[N] as a two's complement data element including a number of bits equal to twice the number of bits of reformatted mantissas InTC and WtTC minus one. The one or more logic gates M1 may be referred to as a multiplier configured to multiply some or all of the instances of reformatted mantissas InTC with some or all of the instances of reformatted mantissas WtTC. In some cases, the multiplier (e.g., the one or more logic gates M1) can receive the signed mantissa InS/InM or the signed mantissa WtS/WtM for the multiplication.

The multiplier circuits 106 are configured to, in operation, generate the number N of products P[1] to P[N]. For example, the multiplier circuits 106 can generate the number N of products P[1]-P[N] equal to sixteen (e.g., sixteen elements). In some other embodiments, the multiplier circuits 106 can generate the number N of products P[1]-P[N] fewer or greater than sixteen, such as eight, thirty-two, sixty-four, etc.

In some embodiments, e.g., those in which data elements InDE and WtDE have the BF16 format, the multiplier circuit 106 is configured to generate each of the products P[1]-P[N] having a total of 17 bits based on each of signed mantissas InS/InM and WtS/WtM and reformatted mantissas InTC and WtTC having a total of nine bits. In some embodiments, e.g., those in which data elements InDE and WtDE have the FP16 format, the multiplier circuit 106 is configured to generate each of products P[1]-P[N] having a total of 23 bits based on each of signed mantissas InS/InM and WtS/WtM and reformatted mantissas InTC and WtTC having a total of 12 bits. Embodiments in which the multiplier circuit 106 is configured to generate each of products P[1]-P[N] having other total bit numbers based on each of signed mantissas InS/InM and WtS/WtM and reformatted mantissas InTC and WtTC having other total bit numbers are within the scope of the present disclosure.

The multiplier circuit 106 is thereby configured to, in operation, perform multiplication and reformatting operations on sign and mantissa bits of input data elements InDE and weight data elements WtDE so as to generate two's complement products P[1]-P[N]. The multiplier circuit 106 is configured to output products P[1]-P[N] to the shifting circuit 112 on a data bus (not shown).

The summing circuits 108 each include one or more data registers (not shown) configured to receive the instances of exponents InE and WtE corresponding to the number of data elements of data elements InDE and WtDE discussed above with respect to the multiplier circuit 106.

The summing circuits 108 each include one or more logic gates A1 configured to, in operation, add each instance of exponent InE to each instance of exponent WtE. In various embodiments, the one or more logic gates A1 include one or more full adder gates, half adder gates, ripple-carry adder circuits, carry-save adder circuits, carry-select adder circuits, carry-look-ahead adder circuits, or other circuits suitable for performing some or all of an addition operation. The respective logic gates A1 of the summing circuits 108 are configured to generate exponent sums S[1]-S[N] as data elements having a total number of bits equal to the number of bits of each of exponents InE and WtE plus one.

The summing circuits 108 are configured to, in operation, generate the exponent sums S[1]-S[N] having the total number N and an ordering of data elements corresponding to the total number N and ordering of the data elements of the products P[1]-P[N] discussed above with respect to the multiplier circuit 106. Accordingly, for a total of N combinations of data elements InDE and WtDE, each n^{th} combination corresponds to both the n^{th} exponent sum S[n] of the exponent sums S[1]-S[N] and the n^{th} product P[n] of the products P[1]-P[N].

In some embodiments, e.g., those in which the data elements InDE and WtDE have the BF16 format, the summing circuit 108 is configured to generate each corresponding one of the exponent sums S[1]-S[N] having a total of nine bits based on each of the exponents InE and WtE having a total of eight bits. In some embodiments, e.g., those in which the data elements InDE and WtDE have the FP16 format, the summing circuit 108 is configured to generate each of the exponent sums S[0]-S[N] having a total of six bits based on each of exponents InE and WtE having a total of five bits. The summing circuit 108 being configured to generate each of the exponent sums S[1]-S[N] having other total bit numbers based on each of exponents InE and WtE having other total bit numbers is within the scope of the present disclosure. The summing circuits 108 are configured to output the exponent sums S[1]-S[N] to the difference circuit 110 on a data bus (not shown).

The difference circuit 110 is an electronic circuit, e.g., an IC, including one or more logic gates L1 (e.g., corresponding to or as a part of a selector circuit 111) and one or more logic gates B1, each configured to receive the exponent sums S[1]-S[N] from the summing circuits 108. The one or more logic gates L1 may sometimes referred to as a selector, and the one or more logic gates B1 may sometimes be referred to as a subtractor. The one or more logic gates L1 are configured to, in operation, generate a maximum exponent sum MaxExp as a data element having a value equal to a maximum value of the data elements of the exponent sums S[1]-S[N] and having a number of bits equal to those of the data elements of the exponent sums S[1]-S[N]. The one or more logic gates L1 are configured to output maximum exponent sum MaxExp to the one or more logic gates B1 and to the converter circuit 124, as discussed below.

The one or more logic gates B1 are configured to, in operation, generate differences D[1]-D[N] by subtracting each data element of the exponent sums S[1]-S[N] from maximum exponent sum MaxExp. The differences D[1]-D[N] thereby have the total number N and ordering of data elements corresponding to that of the exponent sums S[1]-S[N] and the products P[1]-P[N] discussed above. In the embodiment depicted in FIG. 1, the one or more logic gates B1 are configured to output differences D[1]-D[N] to the shifting circuit 112 on one or more data buses (not shown). In some embodiments, the one or more logic gates B1 are not configured to output the differences D[1]-D[N] to the multiplier circuits 106, and the multiplier circuits 106 are each configured to generate each instance P[n] of products P[1]-P[N] by always performing the multiplying operation. In some other embodiments, the one or more logic gates B1 are configured to output the differences D[1]-D[N] to the multiplier circuits 106, respectively, and the multiplier circuits 106 are each configured to generate each instance P[n] of products P[1]-P[N] by selectively performing the multiplying operation based on a corresponding instance D[n].

In various arrangements, the operations of at least one of the summing circuits 108 and/or the difference circuit 110 can be performed before, after, or in parallel to the multiplier circuits 106. In some arrangements, the operations of the individual summing circuits 108 or the difference circuit 110 may be performed sequentially or in parallel.

The shifting circuit 112 is an electronic circuit, e.g., an IC, including one or more registers and/or logic gates configured to perform a shifting operation on each instance P[n] of the products P[1]-P[N] based on the value of the corresponding instance D[n] of the differences D[1]-D[N].

Each instance P[n] of the products P[1]-P[N] is based on the sign and mantissa of a corresponding combination of data elements InDE and WtDE, and each instance D[n] of the differences D[1]-D[N] is based on the sum of the exponents of the same combination. The shifting circuit 112 is configured to, in operation, right-shift each instance P[n] of the products P[1]-P[N] by an amount equal to the corresponding difference D[n], thereby generating shifted products SP[1]-SP[N] in which sign and mantissa bits are aligned in accordance with the summed exponents used to generate the differences D[1]-D[N]. Based on this alignment, the shifting circuit 112 is configured to generate each instance SP[n] of the shifted products SP[1]-SP[N] having a same exponent using the maximum exponent sum MaxExp as a baseline.

To compensate for the right-shifting operation, the shifting circuit 112 can add instances of the sign bit (zero or one) of each product P[n] as the leftmost bits of the corresponding shifted product SP[n]. The number of added instances of the sign bit is equal to the amount of the right shift as determined by the corresponding difference D[n].

In the illustrated embodiment of FIG. 1, the multiplier circuit 106 can generate the corresponding instance P[n] of the products P[1]-P[N] by performing the multiplying operation, as discussed above. The shifting circuit 112 can include one or more shifters to receive the products P[1]-P[N] from the multiplier circuits 106, and selectively output (e.g., shift) one or more of the shifted products SP[1]-SP[N] to the one or more adder circuits 114 based on the respective differences D[1]-D[N]. For example in FIG. 1, the shifted products outputted to the one or more adder circuits 114 may include SP[w]-SP[z], where “w” to “z” may each be one of the integers from 1 to N. In some arrangements, a respective pair of the shifted products (e.g., a first product and a second product) can be outputted to or received by at least one adder circuit 114. In some other arrangements, a number of products (e.g., SP[w]-SP[z] or more than two products) can be outputted to or received by at least one adder circuit 114. In one aspect of the present disclosure, a sum of the number of SP[w]-SP[x] may be equal to N. In another aspect of the present disclosure, a sum of the number of SP[w]-SP[z] may be less than N.

The shifting circuit 112 (e.g., the shifters) can be controlled (e.g., activated) by a number (e.g., N) of signals generated based on comparing corresponding ones of the differences D[1]-D[N] with a difference threshold (not shown in FIG. 1). The difference threshold can be configured based on a distribution of the differences D[1]-D[N]. In an example where the differences D[1]-D[N] are presented as a normal distribution, the difference threshold may be determined at one standard deviation below a mean of the normal distribution. In another example where the differences D[1]-D[N] are still presented as a normal distribution, the difference threshold may be determined at two standard deviations below a mean of the normal distribution. In yet another example where the differences D[1]-D[N] are still presented as a normal distribution, the difference threshold may be determined at any value of standard deviations below a mean of the normal distribution.

When any of the difference, e.g., D[n] where n is an integer between 1 to N, is equal to or less than the difference threshold (sometimes referred to as a “small exponent difference”), the shifting circuit 112 (e.g., the shifter) can be deactivated to block the corresponding shifted product SP[n] from being received by at least one adder circuit 114 (e.g., not shifting the corresponding product P[n] or being decoupled from at least one adder circuit 114). Equivalently, when any of the differences, e.g., D[n], is greater than the difference threshold (sometimes referred to as a “normal exponent difference”), the shifting circuit 112 can be activated to output the corresponding shifted product SP[n] to the at least one adder circuit 114.

In other words, the shifting circuit 112 can shift any of the products P[1]-P[N], and output the shifted products SP[1]-SP[N] to at least one adder circuit (tree) 114 based on comparing the respective differences D[1]-D[N] with the difference threshold. As such, a sum of the number of SP[w]-SP[z] may be equal to N. In some configurations, the shifting circuit 112 may detect that at least one of the products P[1]-P[N] from the multiplier circuits 106 is zero. In such cases, the shifting circuit 112 may not perform a shift to the corresponding product with a value of zero and/or output the product to the adder circuit(s) 114. As a result, the sum of the number of SP[w]-SP[z] may be less than N.

Further, to generate the SP[w]-SP[z], the shifting circuit 112 may right-shift (or left-shift, in some cases) each instance P[n] of the products P[w]-P[z] by an amount equal to a corresponding difference DA[n], thereby aligning sign and mantissa bits in accordance with the summed exponents. In some embodiments, the difference DA[n] may be generated (e.g., by the difference circuit 110) based on subtracting each data element of sums S[w]-S[z] from a maximum exponent sum MaxExp. The maximum exponent sum MaxExp may correspond to a maximum value of the data elements of the sums S[w]-S[z]. Based on this alignment, the shifting circuit 112 can generate each instance SP[n] of the shifted products SP[w]-SP[z] having a same exponent using the maximum exponent sum MaxExp as a baseline.

When any of the differences, e.g., D[n] where n is an integer between 1 to N, is equal to or less than the difference threshold (sometimes referred to as a “small exponent difference”), the shifting circuit 112 may be deactivated to block the corresponding (e.g., shifted) product SP[n] from being received by the adder circuit(s) 114. The product P[n] with such a big exponent difference may be ignored, in some embodiments.

In other words, the shifting circuit 112 can shift all or some of the products P[1]-P[N], and selectively output the corresponding ones of the shifted products SP[1]-SP[N] to the adder circuit(s) 114, based on comparing the respective differences D[1]-D[N] with the difference threshold. As such, a sum of the number of SP[w]-SP[z] (outputted by the shifting circuit 112) may be less than or equal to N. When one or more of the products P[1]-P[N] are ignored (e.g., having their respective exponent differences D[n] equal to or greater than the difference threshold), the sum is less than N; and when none of the products P[1]-P[N] is ignored, the sum is equal to N.

In some embodiments, e.g., those in which the data elements InDE and WtDE have the BF16 format, the shifting circuit 112 is configured to generate each of the shifted products, e.g., the SP[0]-SP[N], having a total of 21 bits based on each of the products P[0]-P[N] having a total of 17 bits. In some embodiments, e.g., those in which the data elements InDE and WtDE have the FP16 format, the shifting circuit 112 is configured to generate each of the shifted products, e.g., the SP[0]-SP[N], having a total of 27 bits based on each of the products P[0]-P[N] having a total of 23 bits. The shifting circuit 112 being configured to generate each of the shifted products SP[0]-SP[N] having other total bit numbers based on each of the products P[0]-P[N] having other total bit numbers is within the scope of the present disclosure.

Based on the products P[0]-P[N] having a two's complement format, the shifting circuit 112 is configured to generate the shifted products, e.g., SP[0]-SP[N], having a two's complement format. As discussed above, in the illustrated example of FIG. 1, the shifting circuit 112 is configured to output the shifted products SP[w]-SP[z] to the adder circuit (tree) 114 on a data bus (not shown).

The adder trees 114, 116 are each an electronic circuit, e.g., an IC, including multiple layers of one or more logic gates (not shown), e.g., as discussed above with respect to one or more logic gates A1 (of the summing circuit 108). For example, the adder trees 114, 116 may include a first layer configured to receive the shifted products SP[w]-SP[z], and a last layer configured to generate a sum 115, 117 (e.g., sum result) as a data element corresponding to a sum of the shifted products SP[w]-SP[z]. In some embodiments, each of one or more successive layers between the first and last layers is configured to receive a first number of sum data elements generated by a preceding layer, and generate a second number of sum data elements based on the first number of sum data elements, the second number being half the first number. Thus, a total number of layers includes the first and last layers and each successive layer, if present.

In some implementations, the one or more adder trees 114 may represent the first layer configured to receive the shifted products SP[w]-SP[z] and generate a number of sum data elements for a subsequent layer. The adder tree 116 may represent the last layer configured to receive the number of sum data elements generated by a preceding layer, such as from the one or more adder trees 114. Although two layers are shown for purposes of providing examples, it should be noted that there may be one or more successive layers between the first and last layers. In certain cases, there may be one layer, such as the first layer, for summing the shifted products SP[w]-SP[z]. For example, the circuit 100 may include at least one adder tree (circuit) 114 for summing the shifted products SP[w]-SP[z], without including the adder tree (circuit) 116.

In some arrangements, at least one padding circuit 118 can be included between each layer of the adder trees 114, 116. In some cases, at least one padding circuit 118 can be included subsequent to at least one of the adder trees 114, 116. For example, each of the padding circuits 118 may be included after each of the adder trees 114 or before the adder tree 116. In some cases, the at least one padding circuit 118 may be included after at least one of the adder trees 114 but not others.

In some embodiments, the sum 115 outputted by the adder tree 114w can be provided to the padding circuit 118w. Each of the padding circuits 118 is an electronic circuit, e.g., an IC, including one or more registers, logic gates, and/or components configured to perform a padding operation on the sum 115, thereby generating padded sum 115S. Similarly, the sum 117 outputted by the adder tree 114z can be provided to the padding circuit 118z to generate padded sum 117S. Each of the padding circuits 118 can, for instance, shift the corresponding sum 115, 117 to cause the shifted sum 115, 117 to satisfy a predefined format (e.g., an integer portion having a value of ‘1’). The operation of the padding circuits 118 can include but is not limited to shifting the sum result (e.g., sum 115, 117), determining whether to pad the sum result, determining a padding pattern, and/or padding (or concatenating) the sum result with the padding pattern. In some cases, the padding circuit 118w may perform a shift operation such that the sum 115 is aligned with the sum 117, for example. The features or operations of the one or more padding circuits 118 can be described in conjunction with at least one of but not limited to FIGS. 2-11.

For example, FIG. 2 depicts an example 200 of shifting a sum result from the circuit 100 of FIG. 1, in accordance with some embodiments. In an exemplary operation, the padding circuit 118 can receive the sum result (e.g., sum 115 or sum 117) from the corresponding adder tree 114 to perform at least one padding operation. As shown in an example block 202, the sum result can include at least an integer part/portion and a fraction part. The sum result may include a sign part (not shown). In the FP32 format, the sum result can include 8 bits in the integer part and 23 bits in the fraction part. For purposes of providing examples of the padding circuit 118 operation(s), the sum result can be a relatively small value, such as 0.000 . . . 1, resulting from the summation of 1.0000xxxx-1.0000xxxx, for example.

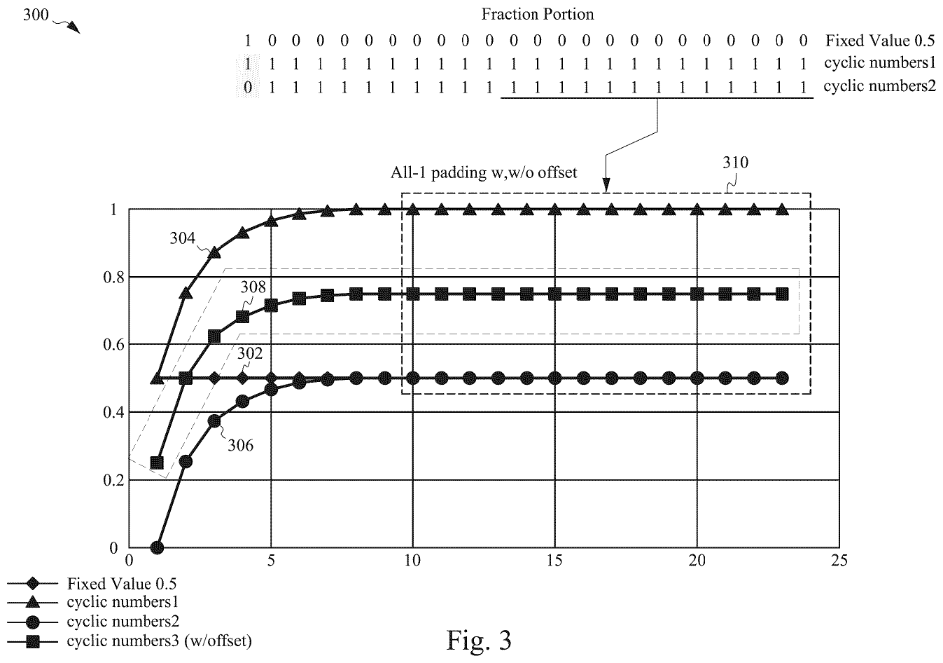

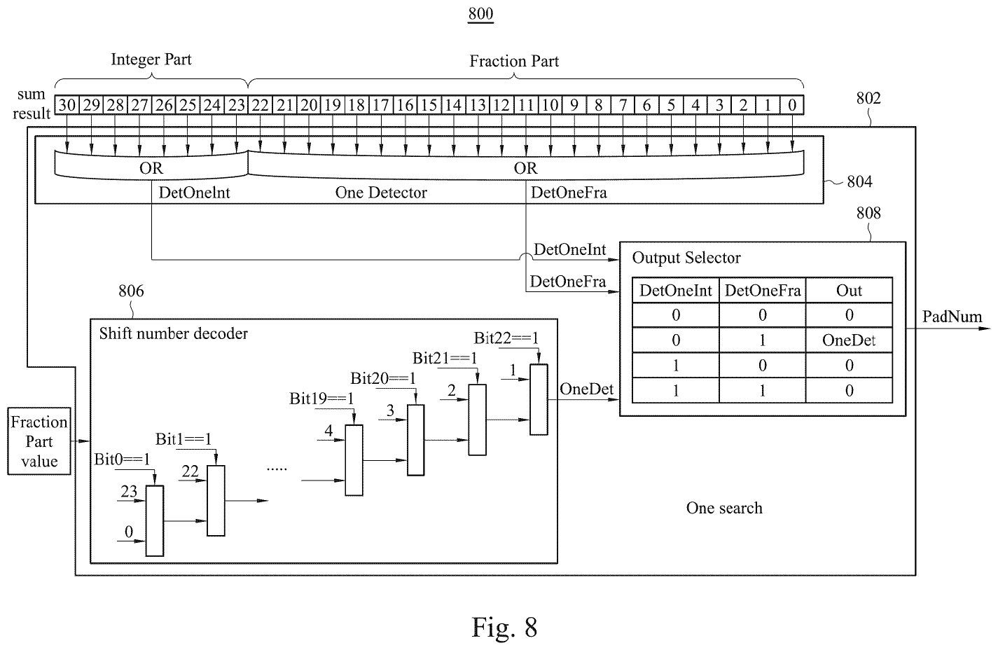

In further examples, the padding circuit 118 can identify the values in each of the bit positions of the sum result. In particular, the padding circuit 118 may identify whether the value in each bit position is ‘0’ or ‘1’, such as described in conjunction with at least FIG. 8. In an example block 204, the padding circuit 118 may identify that there is a ‘1’ in the bit position 0, and that other bit positions are ‘0’. This may represent the worst-case scenario because, after shifting the ‘1’ to the integer portion to satisfy the predefined format (e.g., FP32 format), the fraction part may be filled with all padding bits, which may result in a potentially large error (e.g., rounded off value) if the padding bits are assumed to be zeros. Because the padding circuit 118 identifies a non-zero value in the fraction portion and the integer portion is zero, the padding circuit 118 can determine to pad the sum result with at least one non-zero according to a padding pattern. The padding pattern determination can be described in conjunction with at least one of FIG. 3-7 or 9, among others. For instance, as shown in block 206, the potential rounded-off value (e.g., the padding pattern) can include a range between all zeros and all ones. An example of the resulting values (e.g., the resulting padded sum) using different padding patterns can be described in conjunction with at least FIG. 3.

For example, FIG. 3 depicts a graph 300 mapping a number of bits padded and a corresponding value for the fraction of the sum result from the one or more adders 114 of FIG. 1, in accordance with some embodiments. As shown, the example graph 300 illustrates the resulting value of the fraction portion (y-axis) of a padded sum based on the number of bits padded (x-axis). The example graph 300 includes lines 302-308 corresponding to different paddings used for the fraction portion, e.g., for the shifted sum result in block 206.

For example, line 302 can represent a fixed value of 0.5, when padding with ‘1’ as the most significant bit (MSB) and ‘0’ for other bits. Line 304 can represent a value range from 0.5 to around 1 when using a first pattern, e.g., padding the fraction portion with all ‘1’. For instance, as the padding number (e.g., number of bits to be padded in the fraction portion) increases, such as from 1 to 23 in the FP32 format, the value of the fraction can increase from 0.5 to around 1. Line 306 can represent a value range from 0 to around 0.5 when using a second pattern, e.g., padding the MSB of the fraction portion with ‘0’ and other bits with ‘1’. In this example, as the padding number increases, the value of the fraction can increase from 0 to around 0.5.

In further examples, line 308 can represent a value range between lines 304, 306 when using a third pattern. The third pattern can correspond to the second pattern plus an offset, e.g., 01111 . . . 111+offset value (e.g., 23′h20_0000). The offset value can be a predefined or configurable value. In some cases, the offset value (or the padding pattern) may be selected from a table or an array based on the padding number. Adding the offset value to the second pattern can cause an increase in the magnitude of the values associated with the second pattern (e.g., an increase in the value of the padded sum using the corresponding pattern). In some cases, the offset value may be a negative value for subtracting from the first pattern. For instance, subtracting the offset value from the first pattern can cause a decrease in the magnitude of the values associated with the first pattern (e.g., a decrease in the value of the padded sum using the corresponding pattern). By applying ‘1’ padding with or without the offset, the error level from the loss of information can be minimized.

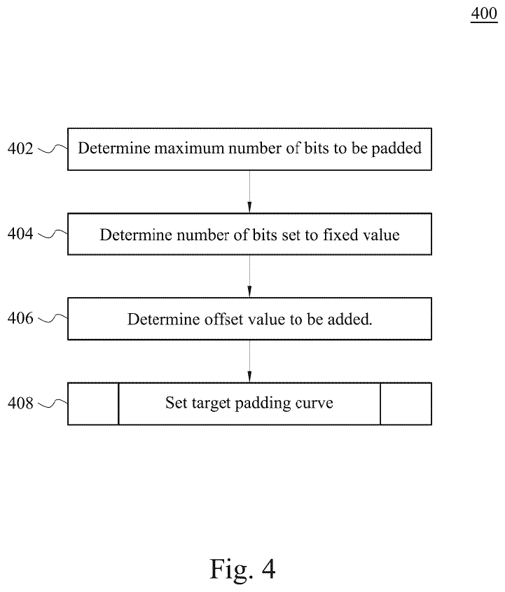

In some configurations, a portion of the padding pattern (e.g., a certain number of LSB) can be a fixed value of ‘0’ or ‘1’. For example, portion 310 of the example graph 300 shows a certain number of LSB padded for the fraction portion. As shown, padding these LSBs (given the size of the padding number) may not significantly affect the overall result of, for instance, the padded sum. As such, a fixed value can be configured for these LSBs (e.g., for portion 310), minimizing resource consumption, including but not limited to memory reduction or computation resource reduction (if the padded sum is used for a subsequent computation). Other operations of the padding circuit 118 (or components of each padding circuit 118) can be described in conjunction with but not limited to at least one of FIGS. 4-11.

It should be noted that while two exemplary adder trees 114 (e.g., adder tree 114w and adder tree 114z) are shown for purposes of providing examples, more or less number of adder trees 114 may be utilized or included in operation. For instance, the circuit 100 may include one adder tree 114 (e.g., adder tree 114w to output the sum 115 without the adder tree 114z). In another example, the circuit 100 may include more than two adder trees 114 to sum the shifted products SP[w]-SP[z]. In some configurations, there may be the same number of padding circuits 118 as the number of adder trees 114. In some other configurations, there may be more or less number of padding circuits 118 compared to the number of adder trees 114, e.g., the padding circuit 118w may be included after the adder tree 114w, and the padding circuit 118z may not be included after the adder tree 114z.

Referring back to FIG. 1, the adder circuit (tree) 116 is an electronic circuit, e.g., an IC, including multiple layers of one or more logic gates (not shown), e.g., as discussed above with respect to one or more logic gates A1 (of the summing circuit 108). For example, the adder tree 116 may include a first layer configured to receive the sums 117S and 115S, and a last layer configured to generate a sum PSTC as a data element corresponding to a sum of the shifted products SP[w]-SP[x] and SP[y]-SP[z]. In some embodiments, each of one or more successive layers between the first and last layers is configured to receive a first number of sum data elements generated by a preceding layer, and generate a second number of sum data elements based on the first number of sum data elements, the second number being half the first number. Thus, a total number of layers includes the first and last layers and each successive layer, if present.

In some embodiments, the adder circuit 116 may receive all the shifted products SP[w]-SP[z] directly from the shifting circuit 112, e.g., the adder circuits 114 may not be included. In this case, the adder circuit 116 can sum the shifted products SP[w]-SP[z] and generate the sum result. The padding circuit 118 may be included after the adder circuit 116, where the adder circuit 116 may determine whether to pad the sum result from the adder circuit 116. In such cases, the padding circuit 118 may perform the padding operation and generate the sum PSTC.

The sum PSTC (e.g., corresponding to the sum of sum 115S and sum 117S) is sometimes referred to as partial sum PSTC or mantissa sum PSTC in some embodiments, having a total number of bits corresponding to the number of bits and number of data elements of the shifted products SP[w]-SP[z]. In some embodiments, the number of bits of sum PSTC is equal to the number of bits of shifted products SP[w]-SP[z] plus a number of bits capable of representing the number of data elements of shifted products SP[w]-SP[z]. In some embodiments, the number of bits of sum PSTC is equal to the number of bits of shifted products SP[w]-SP[z] plus four bits capable of representing 16 data elements of shifted products SP[w]-SP[z].

In some embodiments, e.g., those in which data elements InDE and WtDE have the BF16 format, the adder tree 114 is configured to generate the sum PSTC having a total of 25 bits based on each of the shifted products SP[w]-SP[z] having a total of 21 bits. In some embodiments, e.g., those in which data elements InDE and WtDE have the FP16 format, the adder tree 114 is configured to generate the sum PSTC having a total of 31 bits based on each of the shifted products SP[w]-SP[z] having a total of 27 bits. The adder tree 114 being configured to generate the sum PSTC based on each of the shifted products SP[w]-SP[z] having other total bit numbers is within the scope of the present disclosure.

Based on the shifted products SP[w]-SP[z] having a two's complement format, the adder tree 114 is configured to generate the sum PSTC having a two's complement format, in accordance with various embodiments of the present disclosure. As such, the adder tree 114 is configured to output the sum PSTC to the converter 116 on a data bus (not shown). In some other embodiments, the adder tree 114 may output the sum PSTC to a circuit (not shown) external to the circuit 100.

The converter 116 is an electronic circuit, e.g., an IC, including logic circuitry configured to, in operation, receive the sum PSTC from the adder tree 114, and convert the sum PSTC from two's complement to a sum PSSM having a sign plus mantissa format. The converter 116 is configured to generate the sum PSSM having a same number of bits as that of the sum PSTC. In the embodiment depicted in FIG. 1, the converter 116 is configured to further output the sum PSSM to the converter 118 on a data bus (not shown). In some other embodiments, the converter 116 may output the sum PSSM to a circuit (not shown) external to the circuit 100.

The converter 118 is an electronic circuit, e.g., an IC, including logic circuitry configured to, in operation, receive the sum PSSM from the converter 116 and the maximum exponent sum MaxExp from the difference circuit 110, and convert the sum PSSM from the sign plus mantissa format to a sum PS having an output format based on the sum PSSM and the MaxExp and different from the sign plus mantissa format, e.g., a floating point format as discussed above. In various embodiments of the present disclosure, the converter 118 can generate the sum PS configured to be compatible with a circuit (not shown) external to the circuit 100. For example, the converter 118 is configured to output the sum PS to a circuit (not shown) external to the circuit 100, e.g., a memory array or other instance of the circuit 100 as part of a convolutional neural network (CNN). In some arrangements, the converter 116 can be a part of the converter 118, or vice versa.

FIG. 4 is a flow diagram of a method 400 for determining padding bits for the circuit 100 of FIG. 1, in accordance with some embodiments. The example method 400 can be performed by the circuit 100 or one or more components of the circuit 100. As such, the following embodiment of the method 400 can be described in conjunction with but not limited to at least one of FIGS. 1-3 and/or 5-11. The illustrated embodiment of the method 400 is provided as an example and does not limit the scope of the present disclosure. Therefore, it shall be understood that any of a variety of the operations of the method 400 may be omitted, re-sequenced, and/or added while remaining within the scope of the present disclosure. The method 400 is not limited to the arrangements of the operations discussed herein, such that certain operations may be performed before, during, or after other operations.

The method 400 starts with operation 402 for determining a maximum number of bits to be padded. The maximum number of bits to be padded can be user-defined, pre-configured, or updated according to the desired value for the padded sum (e.g., the desired rounded-off value). In some cases, the maximum number of bits to be padded can be based on the format of the floating point number. For example, the maximum number of bits to be padded can be set based on the width of the mantissa portion according to the format, such as 23 bits for FP32 format (mode). The maximum number of bits to be padded can be set to a different value for FP16, FP8, etc.

The method 400 continues to operation 404 for determining the number of bits to set as a fixed value (e.g., fixed ‘0’ or ‘1’ value). The number of bits to set can be predetermined, configured, or updated according to the user preference or the CIM application. The number of bits to set to the fixed value can be in different positions, such as the 6 LSBs set to ‘1’, 4 MSBs set to ‘1’, a range of bit positions set to ‘0’, etc. Other lengths can be considered depending on the CIM application, for example. Taking the 6 LSBs set to the fixed value as an example, within the FP32 format, a table to store the bit pattern can be reduced from a 23-bit table to a 17-bit table because 6 bits of the 23 bits are set to the fixed value. Hence, the logic circuit occupancy can be reduced proportional to the number of bits set to the fixed value. For purposes of providing examples, a number of LSBs can be set to the fixed value.

The method 400 continues to operation 406 for determining an offset value to be added. The offset value can be a user-defined value or set according to the CIM application. The offset value can include a bit width corresponding to the maximum number of bits to be padded. In some cases, the offset value can include a bit width corresponding to the maximum number of bits to be padded minus the number of bits set to the fixed value. The offset value can be added as part of generating/creating a padding pattern (e.g., padding data pattern). In some cases, the offset value may not be added as configured by the user or according to the CIM application, for example.

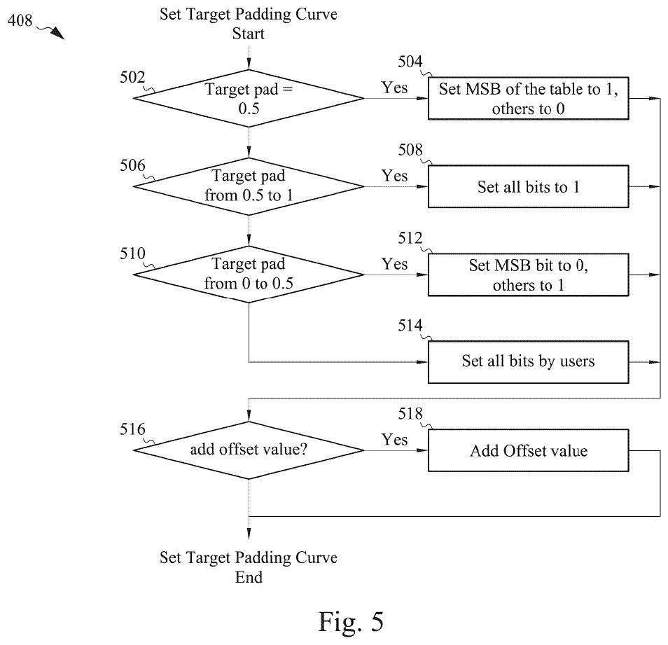

The method 400 continues to operation 408 for setting a target padding curve. Setting the target padding curve can refer to or include setting a padding pattern to obtain the desired curvature or value of at least a portion of the fraction of the padded sum (e.g., an example curvature or at least one of lines 302-308 shown in the example graph 300). The padding pattern can be stored in a table or an array. The operation 408 for setting the target padding curve can be described in conjunction with at least FIG. 5.

FIG. 5 is a flow diagram of a method or operation 408 for setting the target padding curve of FIG. 4, in accordance with some embodiments. For example, the operation 408 starts at operation 502 for determining whether the target pad is set to 0.5. The operation 502 can be subsequent to determining whether there is an offset value to be added. The target pad can be user-defined or according to the CIM application. The target pad can represent the desired value when padding the sum result (e.g., the sum result shown in conjunction with FIG. 2).

At operation 502, if the target pad is set to 0.5, the operation 408 proceeds to operation 504 for setting the MSB of the table (e.g., the padding pattern) to ‘1’ and other bits to ‘0’. In other words, at operation 504, a padding value can be set to have an MSB of ‘1’ and other bits of ‘0’. In this case, the value obtained from padding the sum result can be associated with line 302, as described in conjunction with FIG. 3. If the target pad is not set to 0.5, the operation 408 proceeds to operation 506 for determining whether the target pad is set to a range from 0.5 to around 1. If the target pad is set to the range from 0.5 to around 1, the operation 408 can proceed to operation 508 for setting all bits of the table (e.g., the padding pattern) to ‘1’, e.g., setting the bits of the padding value as all ‘1’.

If the target pad is not set to the range from 0.5 to around 1, the operation 408 can proceed to operation 510 for determining whether the target pad is set to a range from 0 to around 0.5. If the target pad is set to the range from 0 to around 0.5, the operation 408 can proceed to operation 512 for setting the MSB of the padding pattern to ‘0’ and the other bits to ‘1’. In other words, the padding value can be set to have an MSB of ‘0’ and other bits of ‘1’. Otherwise, if the target pad is not set, the operation 408 can proceed to operation 514 for setting the bits in the table (e.g., the padding pattern) according to a predetermined pattern or a user-defined pattern, for example.

The operation 408 continues to operation 516 for determining whether to add an offset value, e.g., to the table representing the padding pattern. The determination of whether to add the offset value may be described in conjunction with at least operation 406 of FIG. 4. For example, if the offset value is defined by the user, the operation 408 can proceed to operation 518 for adding the offset value to the table, for example. In this case, the padding pattern (e.g., the target padding curve) can correspond to the sum of the padding value (from one of the operations 504, 508, 512, 514) and the offset value.

If the offset value is not set, the operation 408 can directly set one of the padding values (from one of the operations 504, 508, 512, 514) as the padding pattern for padding the sum result. The set target padding curve or the padding pattern can be stored in a memory array, the table, or a memory device local to or remote from the circuit 100. The padding circuit 118 can retrieve or access the stored padding pattern to pad the sum result. In various implementations, the padding pattern can be user-defined. For example, the padding pattern may be retrieved or obtained from a memory device, such as local to the circuit 100 or remote from the circuit 100. The padding circuit 118 can use the obtained padding pattern for padding the sum result.

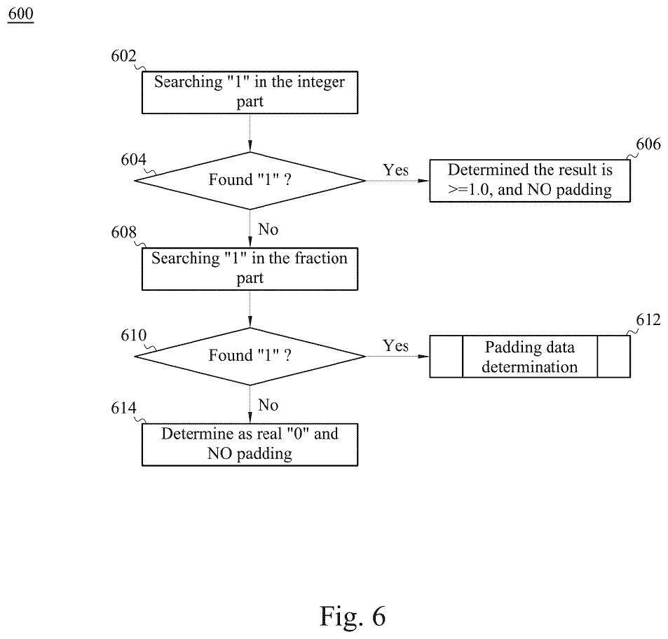

FIG. 6 is a flow diagram of a method 600 for determining whether to pad the sum result of the circuit 100 of FIG. 1, in accordance with some embodiments. The example method 600 can be performed by the circuit 100 or one or more components of the circuit 100, such as the padding circuit 118. As such, the following embodiment of the method 600 can be described in conjunction with but not limited to at least one of FIGS. 1-5 and/or 7-11. The illustrated embodiment of the method 600 is provided as an example and does not limit the scope of the present disclosure. Therefore, it shall be understood that any of a variety of the operations of the method 600 may be omitted, re-sequenced, and/or added while remaining within the scope of the present disclosure. The method 600 is not limited to the arrangements of the operations discussed herein, such that certain operations may be performed before, during, or after other operations.

The method 600 starts with operation 602 for searching ‘1’ bit in the integer part/portion of the sum result. For purposes of providing examples, the method 600 can be described in conjunction with FIG. 8. FIG. 8 is a block diagram 800 of one search component 802 for the circuit 100 of FIG. 1, in accordance with some embodiments. The one search component 802 can be a part of the padding circuit 118. The one search component 802 can be an electronic circuit or component, e.g., an IC, including one or more registers, logic gates, and/or components configured to search for non-zero value and determine a padding number. The one search component 802 can include a one detector 804, a shift number decoder, and an output selector 808. The one detector 804 can be configured to detect one or more non-zero values (e.g., ‘1’) in the bits of the sum result. The shift number decoder 806 can be configured to determine the number of bits to the shift the sum result. The output selector 808 can be configured to select an output for the padding number.

Corresponding to operation 602, the one detector 804 can be configured to detect a ‘1’ in at least one of the integer part and/or the fraction part of the sum result. The one detector 804 can include one or more logic gates, e.g., an OR gate, to generate and output a corresponding signal for the integer part and the fraction part based on whether the value of each part is zero or non-zero.

For example, the bits of the integer part (e.g., bits [30:23] in FP32 format) can be inputs to the one or more logic gates of the one detector 804. If at least one of the bits of the integer part is a ‘1’ bit, the one or more logic gates can generate a ‘1’ signal or a “true” indication as an output for the detection of one in the integer part (DetOneInt). The ‘1’ DetOneInt can indicate that the value of the integer part is non-zero. If the bits of the integer part are all ‘0’, the one or more logic gates can generate a ‘0’ signal or a “false” indication for DetOneInt, indicating that the value of the integer part is zero. The one or more logic gates can output the DetOneInt signal to the output selector 808 for selecting a value as the padding number (PadNum). The output selector 808 can output the padding number to determine the number of bits for the padding pattern. The padding number can be based on at least one of the DetOneInt signal, DetOneFra signal, and/or one detection (OneDet) signal. The output selector 808 can output a padding number of zero if the sum result is not to be padded. The output selector 808 can output the OneDet value as the padding number, indicating the number of bits for padding the sum result and for shifting the sum result, for example.

Responsive to searching for ‘1’ in the integer part, the method 600 continues to operation 604 for determining whether a non-zero value (e.g., ‘1’) is found in the integer part of the sum result. If a non-zero value is found in the integer part of the sum result (e.g., DetOneInt=1), the method 600 continues to operation 606. At operation 606, the output selector 808 can generate a PadNum of zero based on the integer part including a non-zero value. For instance, because a ‘1’ is found in the integer part, the one search component 802 can determine that the sum result is greater than or equal to one, and no padding is needed. Hence, the output selector 808 can output zero as the PadNum because either no shifting is necessary or a right shift may be performed (instead of a left shift) to satisfy the predefined format.

If ‘1’ is not found in the integer part, the method 600 continues to operation 608 to search for ‘1’ in the fraction part of the sum result. The one search component 802 can search for ‘1’ in the fraction part using the one detector 804. The one detector 804 may include one or more logic gates to perform the operations discussed herein, such as similar to the one or more logic gates to search for ‘1’ in the integer part. For example, in the FP32 format, the fraction part can include bits [22:0]. The bits [22:0] can be provided as input to the one or more logic gates, e.g., at least one OR gate. The one or more logic gates of the one detector 804 can generate or output the signal DetOneFra based on whether at least one of the bits in the fraction part includes a non-zero value (e.g., ‘1’). The DetOneFra of ‘1’ can indicate that the fraction part includes a non-zero value. The DetOneFra of ‘0’ can indicate that all bits in the fraction part are zero (e.g., ‘1’ is not found).

Given that the value of the integer part is zero, a value of zero in the fraction part can indicate that the entirety of the sum result (e.g., all bits of the sum result) is zero, and therefore, no padding is to be performed. For example, if all the bits [22:0] in the fraction part are zero, the one or more logic gates of the one detector 804 can generate the signal DetOneFra of ‘0’, indicating no padding for the sum result (e.g., because no left shift is necessary). The one detector 804 can send the DetOneFra signal to the output selector 808. Further, given that the value of the integer part is zero, a non-zero value in the fraction part can indicate at least one left shift is to be performed, and therefore, padding the sum result is desired. For instance, if at least one of the bits [22:0] in the fraction part is non-zero, the one or more logic gates of the one detector 804 can generate the signal DetOneFra of ‘1’, indicating to pad the sum result with non-zero value(s) (e.g., compensating for the loss of information). In this case, when sending the DetOneFra signal to the output selector 808, the output selector 808 can output OneDet as the padding number.

After searching for a non-zero value (e.g., ‘1’) in the fraction part (at operation 608), the method 600 continues to operation 610 for determining whether the non-zero value is found in the fraction part. If ‘1’ is not found in the fraction part, e.g., the one or more logic gates of the one detector 804 for the fraction part returns a ‘0’ DetOneFra, the method 600 continues to operation 614. At operation 614, the one search component 802 can determine that the sum result is a real zero (e.g., all bits are zero) and no padding is needed. In such cases, the one search component 802 (e.g., the output selector 808) can output zero as the padding number.

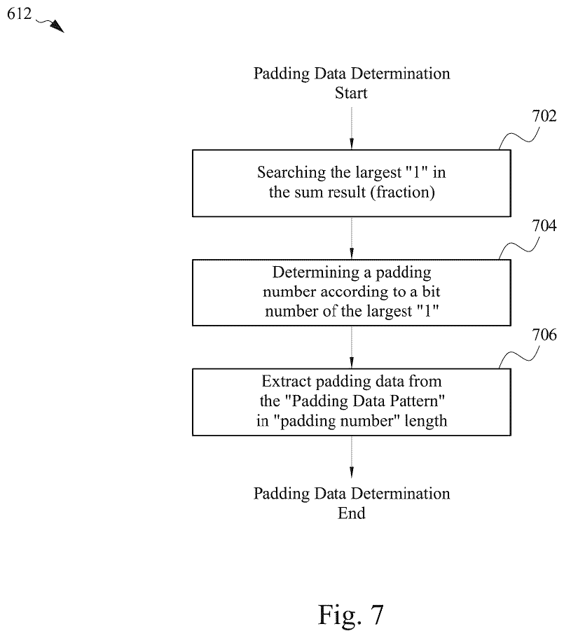

If ‘1’ is found in the fraction part, e.g., the one or more logic gates of the one detector 804 for the fraction part returns a ‘1’ DetOneFra, the method 600 continues to operation 612 for padding data determination. For example, at operation 612, the one search component 802 can determine that the sum result is to be left-shifted (e.g., the integer part is zero and the fraction part is non-zero) and to determine a padding data (or padding pattern) for concatenation. In such cases, the one search component 802 (e.g., the output selector 808) can output OneDet as the padding number. The padding data determination of operation 612 can be described in conjunction with at least FIG. 7, for example.

FIG. 7 is a flow diagram of the operation 612 for padding data determination of FIG. 6, in accordance with some embodiments. The operation 612 can be performed by the padding circuit 118, the components of the padding circuit 118 (e.g., the one search component 802), or other components of the circuit 100. The operation 612 for determining the padding data starts with operation 702 for searching the largest ‘1’ in the fraction part/portion of the sum result.

Corresponding to operation 702, the shift number decoder 806 can receive the fraction part value (e.g., bits of the fraction part of the sum result) as inputs. The shift number decoder 806 can be an electronic circuit or component, e.g., an IC, including one or more registers, logic gates, and/or components configured to search the largest ‘1’ in the fraction part. For example, as shown in FIG. 8, the shift number decoder 806 can include a number (N) of multiplexers (MUX). Each of the N MUX can be associated with a corresponding bit position of the fraction part. In such cases, the number of MUX included in the shift number decoder 806 can correspond to the bit number of the fraction part. Each of the N MUX may correspond to a respective successive layer for determining the number of bits to shift the sum result (or the padding number).

Each MUX can receive three inputs. The first input can include a corresponding bit position value of the fraction part. The first input can be used as a control signal for selecting one of a second input or a third input to provide as an output of the MUX, for instance, to the next successive layer (or as the OneDet). The second input can include the number of bits to shift, for instance, if the corresponding bit position value (e.g., the first input) is the highest/largest ‘1’ (e.g., most significant ‘1’ bit) in the fraction part. The third input can include zero (for the first layer of the successive layers) or the output value carried from the previous layer.

For example, in the case of the FP32 format, the shift number decoder 806 can include 23 MUX. More or less MUX (or other components configured to perform similar tasks) can be included not limited to the 23 MUX, such as for FP16, FP8, etc. Each successive layer of the 23 MUX can be associated with a respective bit position. As shown in FIG. 8, the first MUX can receive the value at bit position 0, the second MUX can receive the value at bit position 1, etc., and the last MUX of the shift number decoder 806 can receive the value at bit position 22. If the value is ‘1’ at a given bit position, the corresponding MUX can output the corresponding number of bits to shift. For instance, if the value of the bit position 0 is ‘1’, the corresponding MUX can output 23, indicating a left shift of 23 bits. In another example, if the bit position 19 is ‘1’, the corresponding MUX can output 4, indicating a left shift of 4 bits. If the value is ‘0’ at a given bit position, the output from the previous successive layer (or prior MUX) can be forwarded to the next MUX (or as OneDet if the MUX is the last/final MUX of the shift number decoder 806). Accordingly, the shift number decoder 806 can determine the bit position (number) of the largest ‘1’ in the fraction part and output the corresponding padding number of the number to shift the sum result (e.g., OneDet). The shift number decoder 806 can output the OneDet to the output selector 808, where the output selector 808 can select the OneDet as the PadNum in response to receiving ‘0’ DetOneInt and ‘1’ DetOneFra from the one detector 804, for example.

Corresponding to operation 704 (continuing from operation 702), the one search component 802 can determine the padding number (PadNum) according to the bit number of the largest ‘1’ in the fraction part. For instance, the shift number decoder 806 can output the OneDet to the output selector 808, indicating the number of bits to shift the sum result. In response to receiving ‘0’ DetOneInt and ‘1’ DetOneFra from the one detector 804, the output selector 808 can select the OneDet as the PadNum. As such, the padding number can correspond to the shift number (e.g., the number of bits to shift the sum result).

In some arrangements, the operation of the shift number decoder 806 can be performed after receiving the signals from the one detector 804. For example, if the one detector 804 outputs ‘1’ DetOneInt and/or ‘0’ DetOneFra to the output selector 808, the output selector 808 can (e.g., directly) output zero as the padding number. In this case, the shift number decoder 806 may not decode the shift number. Otherwise, if the one detector 804 outputs ‘0’ DetOneInt and ‘1’ DetOneFra, the operation of the shift number decoder 806 can be activated/enabled. The output selector 808 can receive the output (e.g., OneDet) from the shift number decoder 806 and output the padding number as OneDet (e.g., the shift number). In some other arrangements, the operation of the shift number decoder 806 may be performed in parallel with the one detector 804 or regardless of the outputs from the one detector 804.

In some implementations, the shift number decoder 806 can include one or more components or features similar to the difference circuit 110, for instance, to determine a difference between the largest non-zero value (e.g., ‘1’) in the fraction part and the maximum number of bits to be padded. For example, the shift number decoder 806 can receive the bits of the fraction part and identify the largest non-zero value in the fraction part. The shift number decoder 806 can receive the maximum number of bits to be padded. The shift number decoder 806 can subtract the maximum number of bits to be padded by the bit position of the largest non-zero value in the fraction part, so as to generate a difference value. This difference value can represent the number of bits to shift the sum result and the padding number.

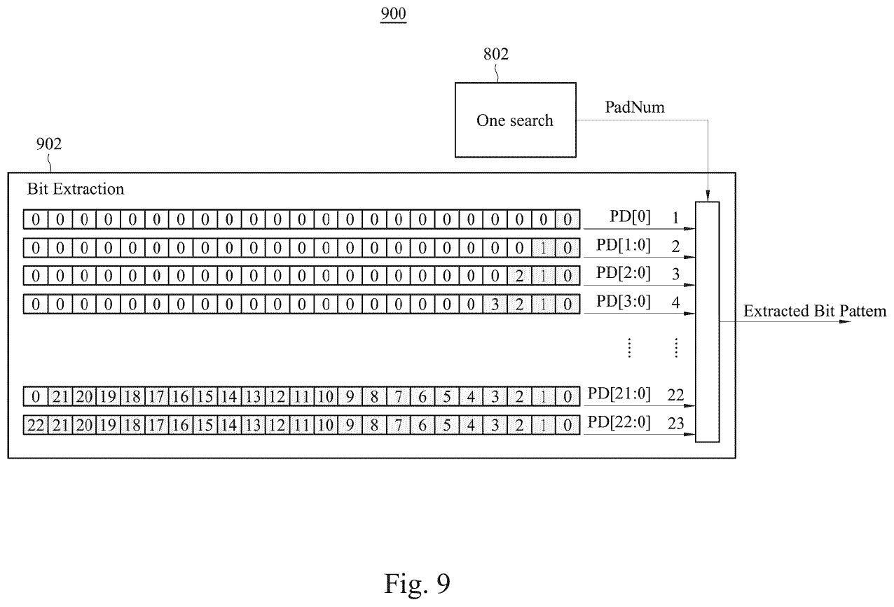

Continuing to operation 706, the padding circuit 118 can be configured to extract padding data having the padding number length from the padding data pattern (e.g., padding pattern). The padding data can be at least a subset of the padding pattern. The extraction of the padding data can be described in conjunction with at least FIG. 9. For example, FIG. 9 is a block diagram 900 of a bit extraction component 902 for the circuit 100 of FIG. 1, in accordance with some embodiments. The bit extraction component 902 can be a part of the padding circuit 118. The bit extraction component 902 can be an electronic circuit or component, e.g., an IC, including one or more registers, logic gates, and/or components configured to extract padding data (or padding pattern or bit pattern) and output the padding pattern for the padding circuit 118 to pad (or concatenate) with the shifted sum result.

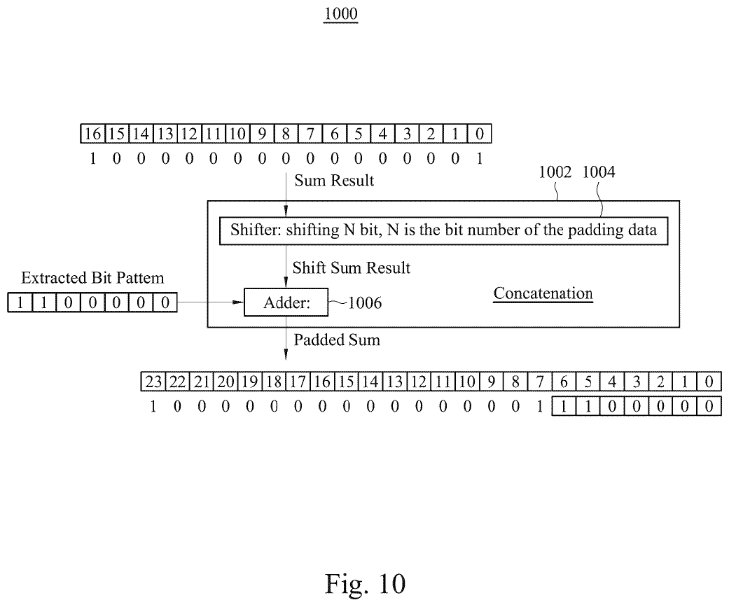

The bit extraction component 902 can include or store N bit patterns corresponding to the maximum number of bits to be padded, e.g., 23 patterns for the FP32 format. The bit extraction component 902 can include a MUX configured to receive each of the N bit patterns as input and the output from the one search component 802 as the control signal. Each of the N bit patterns can be determined, configured, or defined as described in conjunction with but not limited to at least one of FIGS. 4-5. For instance, each bit pattern may include a padding value with or without an offset. Based on the padding number (e.g., the length for the bit pattern), the MUX of the bit extraction component 902 can extract the corresponding bit pattern and output the bit pattern (e.g., padding pattern) for padding the (shifted) sum result. The process for padding the sum result can be described in conjunction with at least FIG. 10.

In some implementations, the bit extraction component 902 may include or store a single bit pattern having the length of the maximum number of bits to be padded. In this case, the bit extraction component 902 can include one or more components configured to extract one or more bits from the bit pattern based on or according to the padding number (e.g., the desired length of the padding pattern). The bit extraction component 902 can output at least a portion of the bit pattern having the length of the padding number. As described in conjunction with FIG. 10, the bit extraction component 902 can output the extracted bit pattern (or the padding pattern) to a concatenation component 1002.

FIG. 10 is a block diagram 1000 of the concatenation component 1002 for the circuit 100 of FIG. 1, in accordance with some embodiments. The concatenation component 1002 can be a part of the padding circuit 118. The concatenation component 1002 can be an electronic circuit or component, e.g., an IC, including one or more registers, logic gates, and/or components configured to concatenate (or pad) the extracted bit pattern (e.g., the padding pattern) with the sum result. The concatenation component 1002 can include at least a shifter circuit 1004 and an adder circuit 1006 to perform the operations discussed herein.

The shifter circuit 1004 can be configured to shift the sum result. For example, the shifter circuit 1004 can receive the sum result from the corresponding adder tree 114, for example. In some cases, the shifter circuit 1004 may receive the padding number from the one search component 802, where the padding number corresponds to the shift number (e.g., the number of bits to shift the sum result). In some other cases, the padding number may be different from the shift number. For purposes of providing examples, the shift number can correspond to the padding number or the bit number of the padding data.

The shifter circuit 1004 can left shift the sum result according to the shift number. The shifter circuit 1004 can generate a shifted sum result in response to shifting the sum result. The shifter circuit 1004 can output the shifted sum result to the adder circuit 1006.

The adder circuit 1006 can be configured to concatenate, add, or pad the shifted sum result with the extracted bit pattern. For example, the adder circuit 1006 can receive the shifted sum result from the shifter circuit 1004 and the bit pattern from the bit extraction component 902 as inputs. The adder circuit 1006 can include one or more logic components to concatenate the shifted sum result by the extracted bit pattern to generate a padded sum. The adder circuit 1006 can output the padded sum to other circuits or components, such as but not limited to the adder tree 116 (or other adder trees 114) or the converter 120. The output of the adder circuit 1006 can be the output of the padding circuit 118. Accordingly, by generating the padded sum for subsequent summation or for the converter 120, the potential information loss can be compensated and the potential error level can be reduced.

In some implementations, the padding pattern can include a fixed value portion (e.g., ‘0’ or ‘1’) and a bit pattern portion (e.g., a combination of ‘1’ and ‘0’). For example, the fixed value portion can include a user-defined number of bits, such as 7 bits of fixed value for purposes of providing examples. The fixed values can be in the LSB part of the padding pattern (e.g., least significant 7 bits). In the case of FP32 format, 16 other bits can be a predefined bit pattern (e.g., the most significant 16 bits of the padding pattern). In this case, if the padding number is below the user-specified number of fixed value, the padding circuit 118 can concatenate the shifted sum result with the fixed value. Otherwise, if the padding number is at or above the user-specified number of fixed value, the padding circuit 118 can concatenate the shifted sum result with a combination of bit pattern and fixed value.

For example, the user-specified value may be 7. If the padding number of the sum result is 3, the padding circuit 118 can pad 3 LSB of the shifted sum result with the fixed value. If the padding number is 12, the padding circuit 118 can pad the 7 LSB of the shifted sum result with the fixed value, and 5 subsequent LSB of the shifted sum result with a portion of the predefined bit pattern.

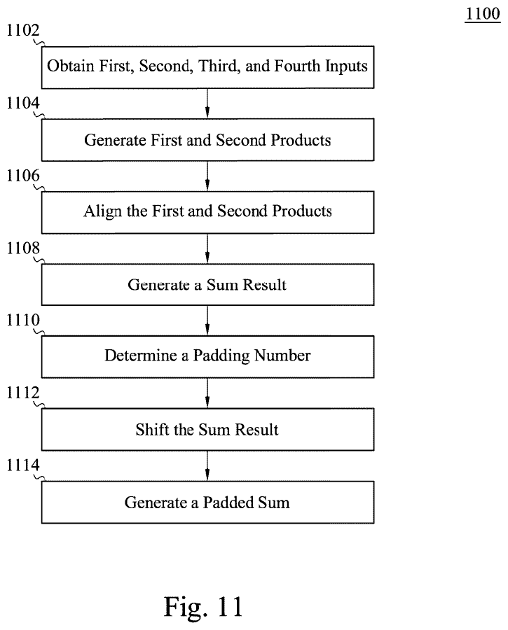

FIG. 11 illustrates a flow chart of an example method 1100 of performing MAC operations on floating point numbers with improved accuracy of CIM, in accordance with various embodiments. The example method 1100 can be performed by the circuit 100 (e.g., sometimes referred to as CIM circuit 100) or one or more components of the circuit 100. As such, the following embodiment of the method 1100 can be described in conjunction with but not limited to at least one of FIGS. 1-10. The illustrated embodiment of the method 1100 is provided as an example and does not limit the scope of the present disclosure. Therefore, it shall be understood that any of a variety of the operations of the method 1100 may be omitted, re-sequenced, and/or added while remaining within the scope of the present disclosure.

The method 1100 starts with operation 1102 for obtaining a plurality of inputs. The circuit 100 (e.g., input circuit 104) can obtain/receive a number (N) of first inputs and N second inputs. Each of the N second inputs and a corresponding one of the N first inputs form one of N input pairs. For example, the N first inputs can include a first input and a third input. The N second input can include a second input and a fourth input. A first pair of inputs can include the first input and the second input. A second pair of inputs can include the third input and the fourth input. Each of the inputs can include a sign portion/part, an exponent portion, and a mantissa portion. For example, the N first inputs can consist of N first signs, N first exponents, and N first mantissas. The N second inputs can consist of N second signs, N second exponents, and N second mantissas.

The method 1100 continues to operation 1104 for generating N products. Each of the N products can be computed based on a respective pair of inputs (e.g., the mantissa portion of the inputs). For example, the circuit 100 (e.g., multiplier circuit(s) 106) can generate a first product by multiplying the first input pair, e.g., the product of a corresponding first mantissa of the first input and a corresponding second mantissa of the second input. The circuit 100 can generate a second product by multiplying the second input pair, e.g., the product of a corresponding third mantissa of the third input and a corresponding fourth mantissa of the fourth input. The circuit 100 can multiply one or more other input pairs to generate the corresponding one or more of N products.

The method 1100 continues to operation 1106 for aligning the products, such as each of the N products. Taking the generated first product and second product as an example, the circuit 100 (e.g., the shifting circuit 112) can align the first product and the second product according to a largest exponent sum of the N products. By aligning the N products to the largest exponent sum, the circuit 100 can generate corresponding N aligned products. The aligned first product and the second product can form a pair of aligned products.

In various implementations, the circuit 100 (e.g., summing circuit 108 and selector circuit 111) can be configured to determine or select the largest exponent sum. For example, the circuit 100 (e.g., summing circuits 108) can combine the exponents of each pair of inputs, such as a corresponding first exponent and a corresponding second exponent of the corresponding one of the N input pairs to generate a respective one of N exponent sums. The circuit 100 (e.g., the selector circuit 111) can select the largest one among the N exponent sums as the largest exponent sum.

In some implementations, the circuit 100 (e.g., subtractor circuit or difference circuit 110) can be configured to determine or compute N exponent differences, where each of the N exponent differences corresponds to an input pair of the N input pairs. For example, the circuit 100 (e.g., difference circuit 110) can calculate a corresponding one of N exponent differences based on a difference between the largest exponent sum and a corresponding one of the exponent sums associated with a corresponding input pair. In this case, each of the N exponent differences can be equal to a difference between a corresponding one of the N exponent sums and the largest exponent sum, for example. In response to obtaining the exponent differences, the circuit 100 (e.g., the shifting circuit 112) can align each of the N products by shifting each of the N products based on the corresponding one of the N exponent differences.

The method 1100 continues to operation 1108 for generating a sum result. The circuit 100 (e.g., adder circuit (tree) 114, 116) can generate a sum result by summing a respective pair of N aligned products. For example, the circuit 100 can generate a sum result by summing the aligned first product and the aligned second product. The sum result can consist of a sign portion/part, an integer portion, and a fraction portion.

The circuit 100 (e.g., padding circuit 118) can determine whether to pad the sum result, for instance, to compensate for information loss. For example, the circuit 100 (e.g., padding circuit 118) can identify a first value associated with the integer portion and a second value associated with the fraction portion of the sum result. The first value can represent the value of one or more bits in the integer portion (e.g., indicating whether there is a non-zero value in the integer portion). The second value can represent the value of one or more bits in the fraction portion (e.g., indicating whether there is a non-zero value in the fraction portion). The circuit 100 can identify the first and second values by identifying the bit values associated with the integer part and the fraction part, respectively. If the first value is a non-zero value (e.g., greater than zero) or the second value is zero, the circuit 100 can determine that the left shift operation may not be performed for the sum result. In this case, the circuit 100 may determine not to pad the sum result. On the other hand, if the first value is zero and the second value is non-zero (e.g., greater than zero), the circuit 100 can determine to perform left shift and padding operations for the sum result because the sum result is a relatively small value.

When determined to pad the sum result, the method 1100 continues to operation 1110 for determining a padding number. The circuit 100 (e.g., the padding circuit 118) can determine the padding number based on a bit position of the largest non-zero (e.g., ‘1’) value in the sum result, such as described in conjunction with at least FIG. 8. For example, to determine the padding number, the circuit 100 can determine the bit position of the largest non-zero value in the fraction portion of the sum result. The circuit 100 can determine the padding number based on a difference between the bit position (of the largest non-zero value) and a predetermined value. The predetermined value can be the maximum number of bits to be padded, which may be user-defined, based on the number format, etc. In some cases, the circuit 100 can identify a number of bits to shift the sum result based on the difference between the bit position of the largest non-zero value and the maximum number of bits to be padded.

In various implementations, the circuit 100 (e.g., the padding circuit 118) can receive a plurality of padding patterns. Each of the plurality of padding patterns can have a corresponding length. For example, a first padding pattern can have a length of 1 bit, a second padding pattern can have a length of 2 bits, a third padding pattern can have a length of 3 bits, etc. The total number of padding patterns may correspond to the maximum number of bits to be padded. The circuit 100 can extract or select the padding pattern from the plurality of padding patterns for concatenation or padding, based on the length of the padding pattern corresponding to the padding number. In some cases, the circuit 100 may include one padding pattern having the length of the maximum number of bits to be padded. In such cases, the circuit 100 can extract at least a portion of the one padding pattern for concatenation based on the padding number.

The method 1100 continues to operation 1112 for shifting the sum result. The circuit 100 (e.g., the padding circuit 118) can shift (e.g., left shift) the sum result by a number of bits corresponding to the padding number (e.g., shift number). The circuit 100 can generate a shifted sum result in response to shifting the sum result.

The method 1100 continues to operation 1114 for generating a padded sum. The circuit 100 (e.g., the padding circuit 118) can generate the padded sum by concatenating a padding pattern having a length of the padding number to the shifted sum result. For example, after shifting the sum result, the shifted sum result can be added, padded, or concatenated with the padding pattern (e.g., bit pattern) to generate the padded sum. The padded sum can include the padding pattern as the one or more LSBs (associated with the length of the padding number).

In some implementations, the padding pattern can be predefined, configured, or updated according to the desired target curve (e.g., as described in conjunction with at least one of FIGS. 3-5, etc.). For example, the circuit 100 (e.g., padding circuit 118) can receive the maximum number of bits to be padded. The circuit 100 can receive a number of bits to set to a fixed value (e.g., ‘1’ or ‘0’). The circuit 100 can receive an offset value. The number of bits to set to the fixed value and/or the offset value can be user-defined or pre-configured according to the CIM application. The circuit 100 can generate a second padding pattern having a length of the maximum number of bits to be padded based on a sum of the number of bits set to the fixed value and the offset value. In this case, the padding pattern may correspond to at least a portion of the second padding pattern according to the length of the padding number. In some other cases, the circuit 100 may generate a plurality of padding patterns associated with respective padding numbers, each of the plurality of padding patterns comprising at least one of the number of bits set to the fixed value and/or the offset value summed to the fixed value.

In some implementations, the circuit 100 can include a second adder circuit (e.g., another adder circuit (tree) 114) configured to sum another respective pair of the N aligned products to generate a corresponding second sum result. In this case, the circuit 100 (e.g., a second padding circuit) can determine a second padding number based on the bit position of the largest non-zero value in the second sum result. The circuit 100 can shift the second sum result by a number of bits corresponding to the second padding number to generate a second shifted sum result. The circuit 100 can concatenate the padding pattern having a length of the second padding number to the second shifted sum result, so as to generate a second padded sum. The circuit 100 (e.g., adder circuit (tree) 116 or the third adder circuit) can sum the padded sum and the second padded sum, so as to generate an accumulated result.

In one aspect of the present disclosure, a computing-in-memory (CIM) circuit is disclosed. The CIM circuit includes an input circuit configured to receive: (i) a number (N) of first inputs, and (ii) N second inputs, wherein each of the N second inputs and a corresponding one of the N first inputs form one of N input pairs; N multiplier circuits, each of the N multiplier circuits configured to multiply a corresponding input pair, so as to generate a corresponding one of N products; a shifting circuit configured to align each of the N products according to a largest exponent sum, so as to generate a corresponding one of N aligned products; an adder circuit configured to sum a respective pair of the N aligned products to generate a corresponding sum result; and a padding circuit configured to: (i) determine a padding number based on a bit position of a largest non-zero value in the sum result, (ii) shift the sum result by a number of bits corresponding to the padding number to generate a shifted sum result, and (iii) apply a padding pattern having a length of the padding number to the shifted sum result, so as to generate a padded sum.

In another aspect of the present disclosure, a computing-in-memory (CIM) circuit is disclosed. The CIM circuit includes an input circuit configured to receive: a first input, a second input, a third input, and a fourth input; a first multiplier circuit configured to multiply the first input by the second input to generate a first product; a second multiplier circuit configured to multiply the third input by the fourth input to generate a second product; a shifting circuit configured to align the first product and the second product according to a largest exponent sum, so as to generate a first aligned product and a second aligned product, respectively; an adder circuit configured to sum the first aligned product and the second aligned product to generate a sum result; and a padding circuit configured to: (i) determine a padding number based on a bit position of a largest non-zero value in the sum result, (ii) shift the sum result by a number of bits corresponding to the padding number to generate a shifted sum result, and (iii) apply a padding pattern having a length of the padding number to the shifted sum result, so as to generate a padded sum.

In yet another aspect of the present disclosure, a method for performing MAC operations on floating point numbers with improved accuracy of compute in memory (CIM) is disclosed. The method includes obtaining, by a computing-in-memory (CIM) circuit, a first input, a second input, a third input, and a fourth input, wherein the first input and the second input form a first input pair, and wherein the third input and the fourth input form a second input pair; generating, by the CIM circuit, a first product by multiplying the first input pair; generating, by the CIM circuit, a second product by multiplying the second input pair; aligning, by the CIM circuit, the first product and the second product according to a largest exponent sum; generating, by the CIM circuit, a sum result by summing the aligned first product and the aligned second product; determining, by the CIM circuit, a padding number based on a bit position of a largest non-zero value in the sum result; shifting, by the CIM circuit, the sum result by a number of bits corresponding to the padding number; and generating, by the CIM circuit, a padded sum by applying a padding pattern having a length of the padding number to the shifted sum result.

As used herein, the terms “about” and “approximately” generally indicates the value of a given quantity that can vary based on a particular technology node associated with the subject semiconductor device. Based on the particular technology node, the term “about” can indicate a value of a given quantity that varies within, for example, 10-30% of the value (e.g., +10%, ±20%, or ±30% of the value).

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A computing-in-memory (CIM) circuit, comprising:
one or more circuits to:
receive a binary number comprising at least an integer portion and a fraction portion;
determine a padding number based on a most significant bit (MSB) of the binary number;
shift the binary number by a number of bits corresponding to the padding number to generate a shifted sum result; and
apply a padding pattern having a length of the padding number to the shifted binary number to generate a padded sum.

2. The CIM circuit of claim 1, wherein the padding number is based on a bit position of the MSB, wherein the MSB is a largest non-zero value in the binary number.

3. The CIM circuit of claim 1, wherein the integer portion comprises a value of zero, and wherein a largest non-zero value in the binary number is in the fraction portion.

4. The CIM circuit of claim 1, wherein to apply the padding pattern, the one or more circuits are to:
concatenate a second binary number corresponding to the padding pattern to the shifted binary number.

5. The CIM circuit of claim 4, wherein subsequent to concatenating, the second binary number correspond to one or more least significant bits (LSBs) of the shifted binary number.

6. The CIM circuit of claim 1, wherein the one or more circuits are to:
receive a plurality of padding patterns, each of the plurality of padding patterns having a corresponding length; and
obtain the padding pattern from the plurality of padding patterns based on the length corresponding to the padding number.

7. The CIM circuit of claim 1, wherein the one or more circuits are to:
generate a second padding pattern, having a length associated with the fraction portion of the binary number, based on a sum of a fixed value and an offset value; and
obtain the padding pattern corresponding to a portion of the second padding pattern based on the length of the padding number.

8. The CIM circuit of claim 1, wherein the padding pattern comprises:
a MSB that is a non-zero value and one or more other bits that are zero values; or
a MSB that is a zero value and one or more other bits that are non-zero values.

9. The CIM circuit of claim 1, wherein the one or more circuits are to:
receive a plurality of input pairs comprising a first input pair and a second input pair;
multiply a first input pair of the plurality of input pairs to generate a first product;
multiply a second input pair of the plurality of input pairs to generate a second product;
shift at least one of the first product or the second product to align the first and second products according to a largest exponent sum; and
sum the aligned first and second products to generate the binary number as a sum result.

10. The CIM circuit of claim 9, wherein the one or more circuits are to:
identify a first value associated with the integer portion and a second value associated with the fraction portion; and
determine to output the binary number based on the first value being greater than zero or the second value being zero; or
determine to pad the binary number based on the first value being zero and the second value being greater than zero.

11. The CIM circuit of claim 9, wherein each input of the plurality of input pairs comprises a signed bit, a number (N) of exponent bits, and N mantissa bits.

12. A method, comprising:
receiving, by a computing-in-memory (CIM) circuit, a binary number comprising at least an integer portion and a fraction portion;
determining, by the CIM circuit, a padding number based on a most significant bit (MSB) of the binary number;
shifting, by the CIM circuit, the binary number by a number of bits corresponding to the padding number to generate a shifted sum result; and
applying, by the CIM circuit, a padding pattern having a length of the padding number to the shifted binary number to generate a padded sum.

13. The method of claim 12, wherein the MSB is a largest non-zero value in the binary number, wherein the largest non-zero value is in the fraction portion of the binary number, and wherein a value of the integer portion of the binary number is zero.

14. The method of claim 12, comprises:
receiving, by the CIM circuit, a number (N) of input pairs comprising a first input pair and a second input pair;
generating, by the CIM circuit, a first product by multiplying the first input pair;
generating, by the CIM circuit, a second product by multiplying the second input pair;
aligning, by the CIM circuit, the first and second products by shifting at least one of the first product or the second product; and
generating, by the CIM circuit, the binary number by summing the aligned first and second products.

15. The method of claim 14, wherein each input of the first and second input pairs consists of a signed bit, a mantissa, and an exponent.

16. The method of claim 15, wherein multiplying each of the first and second input pairs comprises:
multiplying, by the CIM circuit, a first mantissa by a second mantissa of a respective input pair to generate a mantissa product; and
summing, by the CIM circuit, a first exponent and a second exponent of the respective input pair to generate an exponent sum, wherein the mantissa product and the exponent sum are part of a respective product.

17. The method of claim 16, wherein aligning the first and second products comprises:
identifying, by the CIM circuit, a largest exponent sum of the first and second products;
determining, by the CIM circuit, at least one of a first exponent difference based on a difference between a first exponent sum of the first product and the largest exponent sum, or a second exponent difference based on a difference between a second exponent sum of the second product and the largest exponent sum; and
shifting, by the CIM circuit, at least one of the first product or the second product based on the corresponding first or second exponent difference.

18. A computing-in-memory (CIM) circuit, comprising:
one or more circuits to:
receive a binary number comprising an integer portion and a fraction portion;
identify a bit position corresponding to a largest non-zero value in the binary number;
determine, responsive to identifying the largest non-zero value in the fraction portion of the binary number, a padding number based on a bit position associated with the largest non-zero value;
shift the binary number according to the bit position to generate a shifted sum result; and
apply a padding pattern to the shifted binary number to generate a padded sum, wherein the padding pattern have a length of the padding number according to the bit position.

19. The CIM circuit of claim 18, wherein the one or more circuits are to:
output the binary number in response to identifying the largest non-zero value in the integer portion or a value of zero in the fraction portion.

20. The CIM circuit of claim 18, wherein the one or more circuits are to:
receive a number (N) of input pairs comprising N first inputs and N second inputs, wherein each of the N second inputs and a corresponding one of the N first inputs form one of N input pairs;
multiply a corresponding input pair to generate a corresponding one of N products;
align each of the N products according to a largest exponent sum of the N products to generate a corresponding one of N aligned products; and
sum a respective pair of the N aligned products to generate the binary number as a corresponding sum result.
